(19) United States
(12) Patent Application Publication
(10) Pub. No.: US 2020/0028958 A1
(43) Pub. Date: Jan. 23, 2020

(54) COMPUTER SYSTEM, AND METHOD AND PROGRAM FOR SETTING

(71) Applicant: OPTiM Corporation, Saga-shi (JP)

(72) Inventor: Shunji SUGAYA, Tokyo (JP)

(21) Appl. No.: 15/749,869

(22) PCT Filed: Mar. 31, 2017
(86) PCT No.: PCT/JP2017/013828

§ 371 Date: Feb. 2, 2018

(51) Int. Cl. H04M 1/725

(52) U.S. Cl. CPC H04M 1/72519

(57) ABSTRACT

The present invention is to provide a computer system, and a method and a program for setting that are capable to easily change the setting of a terminal device in order to improve the convenience. The computer system for setting, in which a setting terminal remotely inputs the setting of a terminal to be set if the setting screen or the screen transition of the setting terminal is different from that of the terminal to be set receives an input of the setting for the terminal to be set by the setting method of the setting terminal; acquires the terminal type ID of the terminal to be set; and transmits a setting command associated with the input setting for the terminal to be set that is received by the setting method of the setting terminal to the terminal to be set, based on the terminal type ID.

### TECHNICAL FIELD

The present invention relates to a computer system, and a method and a program for setting, in which a setting terminal remotely inputs the setting of a terminal to be set if the setting screen or the screen transition of the setting terminal is different from that of the terminal to be set.

### BACKGROUND ART

Recently, terminal devices such as smart phones and tablets have been widespread. In such terminal devices, the users can change various settings to make the terminal device user-friendly. To change the setting, the user who is familiar with the operation of a terminal device may change the setting of the terminal device owned by the user who is unfamiliar with the operation.

However, the setting screen and the change procedure vary with the type of a terminal device. Thus, even if the user is familiar with the operation, it may be difficult to change the setting of the terminal device owned by the user who is unfamiliar with the operation.

It is known that the setting of such terminal device is changed by acquiring information necessary for the setting of the terminal device based on the tag associated with the terminal device (refer to Patent Document 1).

### CITATION LIST

### Patent Literature

Patent Document 1: JP 2015-115878 A

### SUMMARY OF INVENTION

However, the composition of Patent Document 1 has problems where a tag associated with the type of a terminal device should be prepared and where any setting alone cannot be changed and therefore hardly changes the setting of a terminal device easily.

An objective of the present invention is to provide a computer system, and a method and a program for setting that are capable to easily change the setting of a terminal device in order to improve the convenience.

The present invention provides a computer system, in which a setting terminal remotely inputs the setting of a terminal to be set if the setting screen or the screen transition of the setting terminal is different from that of the terminal to be set, including:
a setting receiving unit that receives an input of the setting for the terminal to be set by the setting method of the setting terminal;
a terminal type ID acquisition unit that acquires the terminal type ID of the terminal to be set; and
a setting command transmission unit that transmits a setting command associated with the input setting for the terminal to be set that is received by the setting method of the setting terminal to the terminal to be set, based on the terminal type ID.

According to the present invention, the computer system for setting, in which a setting terminal remotely inputs the setting of a terminal to be set if the setting screen or the screen transition of the setting terminal is different from that of the terminal to be set receives an input of the setting for the terminal to be set by the setting method of the setting terminal; acquires the terminal type ID of the terminal to be set; and transmits a setting command associated with the input setting for the terminal to be set that is received by the setting method of the setting terminal to the terminal to be set, based on the terminal type ID.

The present invention is the category of a computer system, but the categories of a method, a program, etc., for setting have similar functions and effects.

The present invention can provide a computer system, and a method and a program for setting that are capable to easily change the setting of a terminal device in order to improve the convenience.

### BRIEF DESCRIPTION OF DRAWINGS

FIG. 1 shows a schematic diagram of the system for setting 1.

FIG. 2 shows an overall configuration diagram of the system for setting 1.

FIG. 3 shows a functional block diagram of the computer 10, the setting terminal 100, and the terminal to be set 200.

FIG. 4 shows a flow chart of the setting method input process performed by the computer 10, the setting terminal 100, and the terminal to be set 200.

FIG. 5 shows a flow chart illustrating the command transmission process performed by the computer 10 and the terminal to be set 200.

FIG. 6 shows one example of the first setting screen 300.

FIG. 7 shows one example of the second setting screen 400.

### DESCRIPTION OF EMBODIMENTS

Embodiments of the present invention will be described below with reference to the attached drawings. However, this is illustrative only, and the technological scope of the present invention is not limited thereto.

### Overview of System For Setting 1

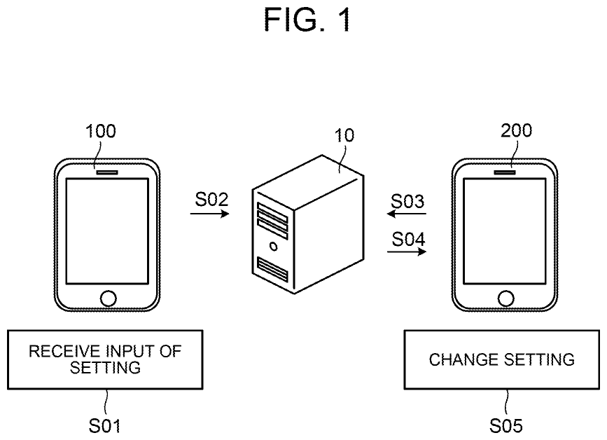

A preferable embodiment of the present invention will be described below with reference to FIG. 1. FIG. 1 shows an overview of the system for setting 1 according to a preferable embodiment of the present invention. The system for setting 1 includes a computer 10, a setting terminal 100, and a terminal to be set 200, which is a computer system, in which the setting terminal 100 remotely inputs the setting of the terminal to be set 200 through the computer 10 if the setting screen or the screen transition of the setting terminal 100 is different from that of the terminal to be set 200.

In FIG. 1, the numbers of the computes 10, the setting terminals 100, and the terminals to be set 200 can be appropriately changed. Furthermore, the setting terminal 100 and the terminal to be set 200 are not be limited to actual devices and may be virtual devices. The processes to be described later may be achieved by any one of or in combination of any two or more of the computer 10, the setting terminal 100, and the terminal to be set 200.

The computer 10 is a computer device data-communicatively connected with the setting terminal 100 and the terminal to be set 200.

The setting terminal 100 is a terminal device that is capable of data communication with the computer 10 and the terminal to be set 200. The setting terminal 100 is a terminal device that a user is familiar with the operation owns. Examples of the setting terminal 100 include electrical appliances such as a mobile phone, a mobile information terminal, a tablet terminal, a personal computer, a net book terminal, a slate terminal, an electronic book terminal, and a portable music player, and wearable terminals such as smart glasses and a head mounted display.

The terminal to be set 200 is a terminal device that is capable of data communication with the computer 10 and the setting terminal 100. The terminal to be set 200 is a terminal device that a user is unfamiliar with the operation owns. The terminal to be set 200 is an electrical appliance, a wearable terminal, and other articles similar to the above-mentioned setting terminal 100.

The setting terminal 100 receives an input of the setting for the terminal to be set 200 by the setting method of the setting terminal 100 (Step S01). The setting terminal 100 inputs the setting performed for the terminal to be set 200 to the setting terminal 100 itself.

For example, the setting terminal 100 acquires the setting of a wireless network set in the terminal to be set 200, from the terminal to be set 200, virtually achieves the connection to the wireless network of the setting terminal 100 based on the acquired setting of the wireless network, and receives an input by the setting method of the setting terminal 100.

The setting terminal 100 transmits the received setting change data indicating the received setting method to the computer 10 (Step S02). The setting change data include the content of the input that the setting terminal 100 received, a setting method, and the identifier of the setting terminal 100. The setting terminal 100 determines the setting method based on the screen transition of the setting screen that the setting terminal 100 displays. In this embodiment, the setting terminal 100 determines the setting method of two or more of screen transitions.

The computer 10 receives the setting change data. The computer 10 acquires the terminal type ID of the terminal to be set 200 (Step S03).

The computer 10 specifies a setting command associated with the input setting for the terminal to be set 200 that is received by the setting method of the setting terminal 100, based on the acquired terminal type ID and transmits the specified setting command to the terminal to be set 200 (Step S04).

The terminal to be set 200 receives the setting command. The terminal to be set 200 changes its own setting based on this setting command (Step S05).

### System Configuration of System For Setting 1

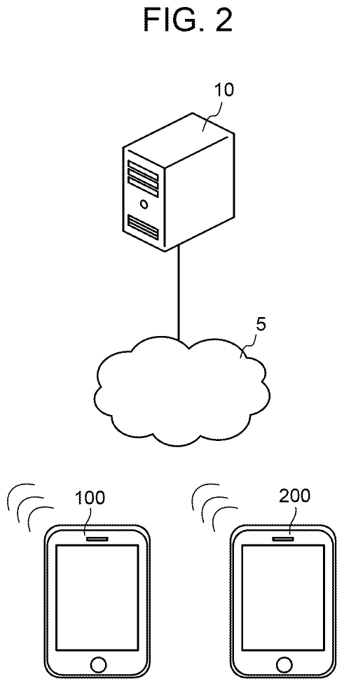

A system configuration of the system for setting 1 according to a preferable embodiment will be described below with reference to FIG. 2. FIG. 2 shows a block diagram illustrating the system for setting 1 according to a preferable embodiment of the present invention. The system for setting 1 includes a computer 10, a setting terminal 100, a terminal to be set 200, and a public line network 5 (e.g., the Internet network, the third or the fourth generation communication network), which is a computer system, in which the setting terminal 100 remotely inputs the setting of the terminal to be set 200 if the setting screen or the screen transition of the setting terminal 100 is different from that of the terminal to be set 200. In the case where the setting screen or the screen transition of the setting terminal 100 is different from that of the terminal to be set 200, the same setting of the setting terminal 100 as that of the terminal to be set 200 should be input through different setting screens or screen transitions.

The number and the type of devices that compose the system for setting 1 can be appropriately changed. The system for setting 1 may not include actual devices and may be achieved with virtual devices. The processes to be described later may be achieved by any one of or in combination of any two or more of the devices that compose the system for setting 1.

The computer 10 is the above-mentioned computer device with the functions to be described later.

The setting terminal 100 is the above-mentioned terminal device with the functions to be described later.

The terminal to be set 200 is the above-mentioned terminal device with the functions to be described later.

### Functions

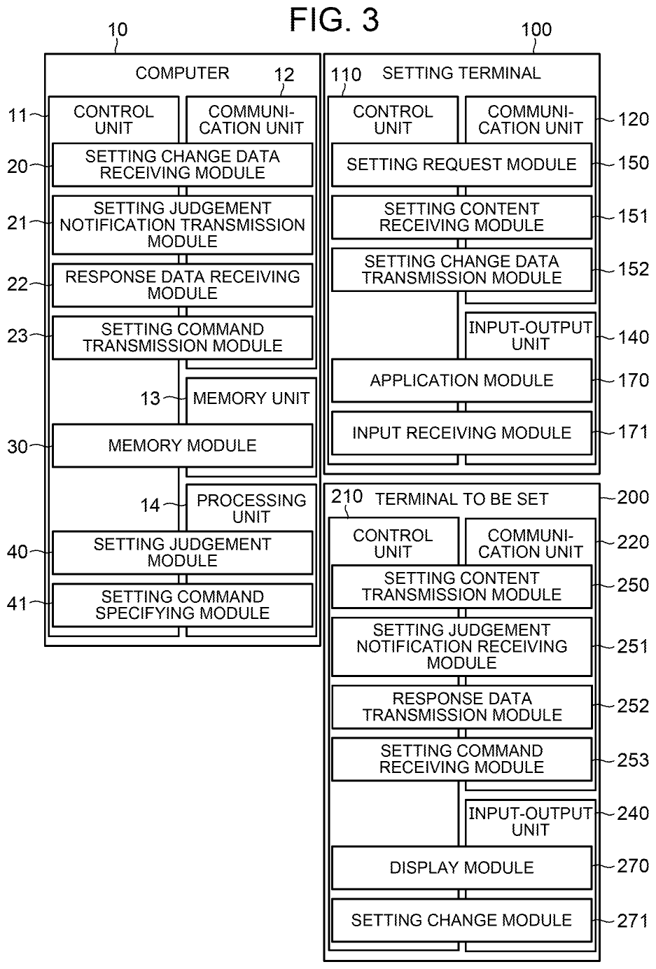

Functions of the system for setting 1 according to a preferable embodiment will be described below with reference to FIG. 3. FIG. 3 shows a functional block diagram of the computer 10, the setting terminal 100, and the terminal to be set 200.

The computer 10 includes a control unit 11 provided with a central processing unit (hereinafter referred to as “CPU”), a random access memory (hereinafter referred to as “RAM”), and a read only memory (hereinafter referred to as “ROM”); and a communication unit 12 such as a device that is capable to communicate with other devices, for example, a Wireless Fidelity or Wi-Fi® enabled device complying with IEEE 802.11. The computer 10 also includes a memory unit 13 such as a hard disk, a semiconductor memory, a record medium, or a memory card to store data. The computer 10 also includes a processing unit 14 provided with various devices that perform various calculations, processes, etc.

In the computer 10, the control unit 11 reads a predetermined program to achieve a setting change data receiving module 20, a setting judgement notification transmission module 21, a response data receiving module 22, and a setting command transmission module 23 in cooperation with the communication unit 12. Furthermore, in the computer 10, the control unit 11 reads a predetermined program to achieve a memory module 30 in cooperation with the memory unit 13. Still furthermore, in the computer 10, the control unit 11 reads a predetermined program to achieve a setting judgement module 40 and a setting command specifying module 41 in cooperation with the processing unit 14.

The setting terminal 100 includes a control unit 110 including a CPU, a RAM, and a ROM; and a communication unit 120 such as a Wi-Fi® enabled device that is capable to communicate with other devices, in the same way as the computer 10. The setting terminal 100 also includes various devices such as a display unit that outputs and displays data and images processed by the control unit 110 and an input unit such as a touch panel, a keyboard, or a mouse that receives an input from the user as an input-output unit 140.

In the setting terminal 100, the control unit 110 reads a predetermined program to achieve a setting request module 150, a setting content receiving module 151, and a setting change data transmission module 152 in cooperation with the communication unit 120. Furthermore, in the setting terminal 100, the control unit 110 reads a predetermined program to achieve an application module 170 and an input receiving module 171 in cooperation with the input-output unit 140.

The terminal to be set 200 includes a control unit 210 including a CPU, a RAM, and a ROM, a communication unit 220 such as a device that is capable to communicate with other devices, and an input-output unit 240 including various devices such as a display unit and an input unit, in the same way as the setting terminal 100.

In the terminal to be set 200, the control unit 210 reads a predetermined program to achieve a setting content transmission module 250, a setting judgement notification receiving module 251, a response data transmission module 252, and a setting command receiving module 253 in cooperation with the communication unit 220. Furthermore, in the terminal to be set 200, the control unit 210 reads a predetermined program to achieve a display module 270 and a setting change module 271 in cooperation with the input-output unit 240.

### Setting Method Input Process

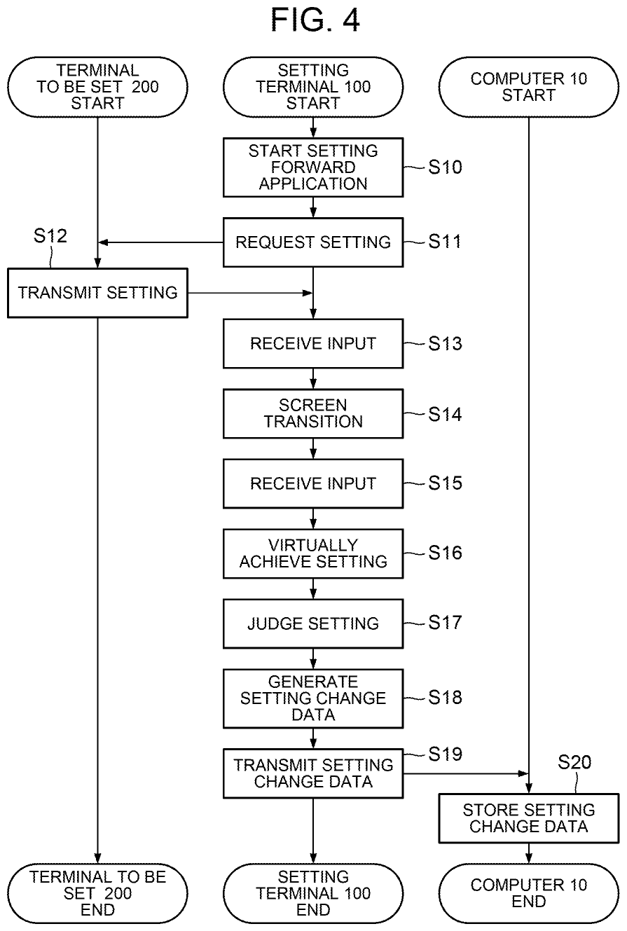

The setting method input process performed by the system for setting 1 will be described below with reference to FIG. 4. FIG. 4 shows a flow chart of the setting method input process performed by the computer 10, the setting terminal 100, and the terminal to be set 200. The tasks executed by the modules of each of the above-mentioned devices will be explained below together with this process.

The application module 170 starts the setting forward application (Step S10). In the step S10, the application module 170 starts the setting forward application that runs in the background. This setting forward application is to perform, for example, the record of the screen transition necessary for the setting that the user input and the record of the content of the received input.

The setting request module 150 requests the terminal to be set 200 to provide the setting that the user of the terminal to be set 200 desires (Step S11). In this embodiment, the setting terminal 100 remotely sets a wireless network for the terminal to be set 200. Specifically, in the step S11, the setting request module 150 requests the setting regarding a wireless network. Examples of the setting regarding a wireless network include an SSID and a password for the wireless network with which the terminal to be set 200 is connected.

The setting content transmission module 250 transmits the setting of the wireless network that is to be set in the terminal to be set 200 to the setting terminal 100, in response to the request that the setting terminal 100 has transmitted (Step S12). In the step S12, the setting content transmission module 250 transmits an SSID, the password thereof, etc., for connection with a network device such as a router as the setting of the wireless network. Examples of the content of the setting include information directly input from the user of the terminal to be set 200 and images containing the information.

The setting content receiving module 151 receives the setting for the wireless network for the terminal to be set 200. The input receiving module 171 receives an input necessary to display the setting screen as an input of the setting for the terminal to be set 200 (Step S13). In the step S13, the input receiving module 171 displays the first setting screen in response to receipt of an input tapped on the setting icons or the setting items of the setting terminal 100. This first setting screen displays various setting icons or setting items corresponding to two or more setting screen. The input receiving module 171 displays the second setting screen corresponding to the setting icon or the setting item in response to receipt of an input any one of the setting icons and the setting items.

In this embodiment, the input receiving module 171 receives an input to a setting icon or a setting item regarding to the setting of a wireless network.

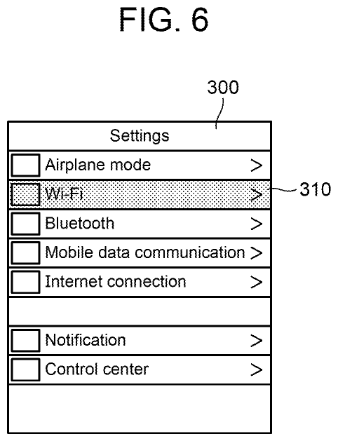

The first setting screen will be described below with reference to FIG. 6. FIG. 6 shows one example of the first setting screen 300. The first setting screen 300 displays two or more setting icons or setting items, which displays a setting screen corresponding to the setting icon or the setting item in response to receipt of an input any one of the setting icons and the setting items. The input receiving module 171 receives an input to a setting item 310 regarding to the setting of a wireless network.

The input receiving module 171 displays the second setting screen based on the input to the first setting screen (Step S14). In the step S14, the input receiving module 171 displays the second screen corresponding to the setting item regarding the connection of a wireless network displayed on the first setting screen.

The input receiving module 171 receives an input of the setting of the wireless network to the second setting screen (Step S15). In the step S15, the input receiving module 171 receives an input of an SSID and a password for the setting terminal 100 to the setting screen of the setting terminal 100. At this time, the input receiving module 171 receives an input of the setting of the wireless network of the terminal to be set 200 by the setting method of the setting terminal 100.

The application module 170 virtually achieves the connection of the wireless network for the terminal to be set 200 based on the input SSID and password (Step S16). In the step S12, the application module 170 achieves this process by using the setting forward application. For example, the application module 170 virtually displays the SSID and the password necessary for the connection of the wireless network to be set in the terminal to be set 200 and the connection with this wireless network by the setting method of the setting terminal 100. The application module 170 does not change the setting for the current connection of the wireless network of the setting terminal 100 but displays the virtually set the connection of a new wireless network.

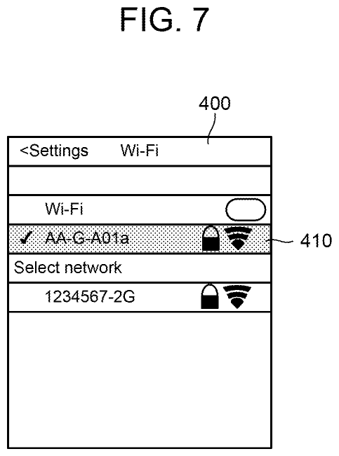

The second setting screen will be described below with reference to FIG. 7. FIG. 7 shows one example of the second setting screen 400. The second setting screen 400 is displayed from the first setting screen 300 to perform a necessary setting. The second setting screen 400 displays two or more setting icons or setting items, which displays the setting screen corresponding to the setting icon or the setting item in response to receipt of an input any one of the setting icons and the setting items, in the same way as the above-mentioned first setting screen 300.

The second setting screen 400 is displayed when an input to a setting icon corresponding to a Wi-Fi setting among the setting icons of the first setting screen 300 is received. The second setting screen 400 displays that the virtually set connection of the wireless network for the terminal to be set 200 is set. At this time, the application module 170 displays the setting item 410 that shows the connection to this wireless network is established based on the SSID and the password for the terminal to be set 200. For example, the setting item 410 displays the name, the identifier, the device name, and the connection status for this wireless network.

The above-mentioned description explains only the first and the second setting screens. However, if the setting change is not completed on the second setting screen, the present invention receives an input of the setting to be set in the terminal to be set 200 by repeating a process similar to the above-mentioned process until the setting change is completed

The application module 170 judges what was set based on the transition of the setting screen that receives an input (Step S17). In the step S17, the application module 170 judges which setting scenario this screen transition corresponds to, based on the setting scenario that associates one or more screens stored in the setting terminal 100 and the transition status of the screens with the actual content of the setting. In this embodiment, the application module 170 judges the transition status regarding the connection of a wireless network based on the setting scenario.

The application module 170 generates the setting change data associated with the content of the received input, the content of the judged setting, and the terminal type ID of the setting terminal 100 (e.g., the identifier to identify the terminal, the identifier of the manufacturer of the terminal, and the model) (Step S18). The content of the received input is necessary for the connection of a wireless network, including an SSID and a password.

The setting change data transmission module 151 transmits setting change data to the computer 10 (Step S19).

The setting change data receiving module 20 receives the setting change data. The memory module 30 stores the setting change data (Step S20).

### Command Transmission Process

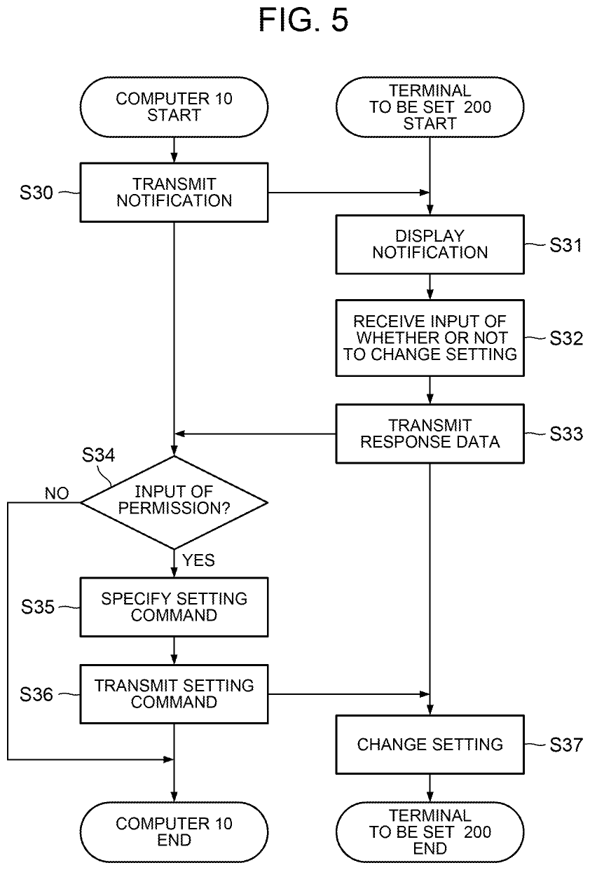

The command transmission process performed by the system for setting 1 will be described below with reference to FIG. 5. FIG. 5 shows a flow chart illustrating the command transmission process performed by the computer 10 and the terminal to be set 200. The tasks executed by the modules of each of the above-mentioned devices will be explained below together with this process.

The setting judgement notification transmission module 21 transmits a notification indicating whether or not the setting can be changed to the terminal to be set 200 (Step S30). The notification indicating whether or not the setting can be changed notifies whether or not the terminal to be set 200 permits to change the setting to the above-mentioned setting change data. If the terminal to be set 200 does, the notification includes a request to acquire the terminal type ID of the terminal to be set 200.

The setting judgement notification receiving module 251 receives the notification of whether or not the setting can be changed. The display module 270 displays this notification (Step S31).

The display module 270 receives an input of whether or not the setting can be changed (Step S32). In the step S32, the display module 270 receives, for example, an input to a displayed permission icon as the input of permission for changing the setting. The display module 270 also receives, for example, an input to a displayed rejection icon as the input of rejection for changing the setting.

The response data transmission module 252 transmits the received input of permission or rejection and the terminal type ID of the terminal to be set 200 to the computer 10 as response data (Step S33). In the step S33, the response data transmission module 252 transmits only an input of rejection if the setting is rejected from changing. On the other hand, the response data transmission module 252 transmits an input of permission and the terminal type ID of the terminal to be set 200 as response data if the setting is permitted to be changed.

The response data receiving module 22 receives the response data. The computer 10 acquires the terminal type ID of the terminal to be set 200 in response to receipt of the response data.

The setting judgement module 40 judges whether or not the response data indicates an input of permission (Step S34). In the step S34, the setting judgement module 40 judges whether or not the response data indicates an input of rejection or an input of permission and a terminal type ID. For example, the setting judgement module 40 makes a judgement based on the presence or absence of a terminal type ID.

If judging that the response data does not indicate an input of permission (NO) in the step S34, the setting judgement module 40 ends this process.

On the other hand, if the setting judgement module 40 judges that the response data indicates an input of permission (YES) in the step S34, the setting command specifying module 41 specifies a setting command associated with the input setting for the terminal to be set 200 that is received by the setting method of the setting terminal 100, based on the stored setting change data and the acquired response data (Step S35). In the step S35, the setting judgement module 40 specifies a setting command by referring to the terminal setting table stored in the memory module 30 that associates a setting command with the content of a setting and a terminal type ID.

### Terminal Setting Table

The terminal setting table stored in the memory module 30 will be described below. The memory module 30 previously associates a setting command with the content of a setting and a terminal type ID and stores the associated data as the terminal setting table. The content of a setting is the content of an input necessary to change the various settings of a terminal (e.g., the transition method of screens, the order of a screen transition, an SSID, and a password). The terminal type ID is as described above. The setting commands are various commands that the terminal to be set 200 performs.

The setting command specifying module 41 specifies the setting command associated with the content of the judged setting included in the setting change data and the terminal type ID of the terminal to be set 200 from the terminal setting table. For example, since the content of the setting specified this time is a setting method of “Wi-Fi® connection,” the setting command specifying module 41 identifies the terminal type ID acquired this time among the terminal type IDs associated with the content of this setting.

Then, the setting command specifying module 41 specifies a setting command associated with the terminal type ID identified this time. The setting command specifying module 41 adds the content of the received input to the specified setting command to specify a setting command to be actually transmitted to the terminal to be set 200. Specifically, the setting command specifying module 41 specifies a screen transition necessary for the terminal to be set 200 to set a setting and the content to be actually set as the setting command. For example, the setting command specifying module 41 adds the input SSID and password to the setting method regarding “Wi-Fi® connection” that is the content of the setting specified this time to specify a setting command.

The setting command transmission module 23 transmits the specified setting command to the terminal to be set 200 (Step S36).

The setting command receiving module 253 receives the setting command. The setting change module 271 changes the setting of the terminal to be set 200 based on this setting command (Step S37). In the step S37, the setting change module 271 automatically changes the setting of the terminal to be set 200 without receipt of input from the user. For example, the terminal to be set 200 displays its own setting screen corresponding to “Wi-Fi® connection” and inputs the SSID and the password input from the setting terminal 100 to a predetermined part based on the setting method of “Wi-Fi® connection” input from the setting terminal 100. The setting change module 271 changes the destination to connect to the network device associated with the SSID and the password. As the result, the terminal to be set 200 communicates with the network device.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### REFERENCE SIGNS LIST

1 System for setting
10 Computer
100 Setting terminal
200 Terminal to be set

1. A computer system, in which a setting terminal remotely inputs the setting of a terminal to be set if the setting screen or the screen transition of the setting terminal is different from that of the terminal to be set, comprising:
a setting receiving unit that receives an input of the setting for the terminal to be set by the setting method of the setting terminal;
a terminal type ID acquisition unit that acquires the terminal type ID of the terminal to be set; and
a setting command transmission unit that transmits a setting command associated with the input setting for the terminal to be set that is received by the setting method of the setting terminal to the terminal to be set, based on the terminal type ID,
wherein the terminal to be set includes a setting transmission unit that transmits the setting of a wireless network set in the terminal to be set to the setting terminal;
the setting terminal includes a wireless network receiving unit that receives the transmitted setting of the wireless network for the terminal to be set; and
the setting receiving unit virtually achieves the connection of the setting terminal based on the received setting of the wireless network and receives an input by the setting method of the setting terminal.

2. The computer system according to claim 1, wherein the setting method of the setting terminal includes two or more screen transitions.

3. (canceled)

4. A method for setting performed by a computer system, in which a setting terminal remotely inputs the setting of a terminal to be set if the setting screen or the screen transition of the setting terminal is different from that of the terminal to be set, comprising the steps of:
receiving an input of the setting for the terminal to be set by the setting method of the setting terminal;
acquiring the terminal type ID of the terminal to be set; and
transmitting a setting command associated with the input setting for the terminal to be set that is received by the setting method of the setting terminal to the terminal to be set, based on the terminal type ID,
wherein the terminal to be set transmits the setting of a wireless network set in the terminal to be set to the setting terminal;
the setting terminal receives the transmitted setting of the wireless network for the terminal to be set; and
receiving the input of the setting includes virtually achieving the connection of the setting terminal based on the received setting of the wireless network and receiving the input by the setting method of the setting terminal.

5. A computer program product for use in a computer system for setting, in which a setting terminal remotely inputs the setting of a terminal to be set if the setting screen or the screen transition of the setting terminal is different from that of the terminal to be set, the computer program product comprising a non-transitory computer usable medium having a set of instructions physically embodied therein, the set of instructions including computer readable program code, which when executed by the system causes a processor to execute the steps of:
receiving an input of the setting for the terminal to be set by the setting method of the setting terminal;
acquiring the terminal type ID of the terminal to be set; and
transmitting a setting command associated with the input setting for the terminal to be set that is received by the setting method of the setting terminal to the terminal to be set, based on the terminal type ID,
wherein the terminal to be set transmits the setting of a wireless network set in the terminal to be set to the setting terminal;
the setting terminal receives the transmitted setting of the wireless network for the terminal to be set; and
receiving the input of the setting includes virtually achieving the connection of the setting terminal based on the received setting of the wireless network and receiving the input by the setting method of the setting terminal.
